(19) United States
(12) Patent Application Publication
(10) Pub. No.: US 2004/0192800 A1
(43) Pub. Date: Sep. 30, 2004

(54) Unreinforced reaction injection molded structural foams

(76) Inventors: Trent A. Shidaker, Troy, MI (US); David W. Bareis, Shelby Township, MI (US)

Correspondence Address: Patent Counsel, Huntsman International LLC, 286 Mantua Grove Road, West Deptford, NJ, 08066-1732, US

(21) Appl. No.: 10/772,516

(22) Filed: Feb. 5, 2004

Related U.S. Application Data
(60) Provisional application No. 60/445,699, filed on Feb. 6, 2003.

(51) Int. Cl. C08G 18/00

(52) U.S. Cl. 521/164

(57) ABSTRACT

A reaction system used to produce an unreinforced structural foam molding includes a polyisocyanate component, an organic isocyanate-reactive component, an isocyanate foaming agent and optionally an additive. The reaction system can be used in a reaction injection molding process where the reaction system is first blended to form a liquid reacting mixture that is injected into a mold. After the liquid reacting mixture foams and cures within the mold, the mold is opened and the unreinforced structural foam molding is removed.

### CROSS-REFERENCE TO RELATED APPLICATIONS

This application claims priority to U.S. Provisional Application No. 60/445,699, filed Feb. 6, 2003.

### BACKGROUND OF THE INVENTION

1. Field of the Invention

The invention relates in general to structural foam moldings prepared by a reaction injection molding process. More particularly, this invention provides structural foam moldings that are free of fiber-reinforcing materials.

2. Description of Related Art

The related art can be reviewed via the following issued patents.

Issued Patents

The full disclosures of the following patents are all incorporated herein by this reference:

U.S. Pat. No. 5,670,553 Internal mold release compositions

U.S. Pat. No. 5,576,409 Internal mold release compositions

A reaction injection molding (“RIM”) process is used to produce shaped moldings. The RIM process involves forming a liquid reaction mixture by combining a liquid polyisocyanate with a liquid organic isocyanate. The liquid reaction mixture is then injected into a mold cavity to produce the shaped molding.

In order to make the shaped molding stronger, a reinforcing material is generally added during the RIM process. For example, short-fiber reinforcing materials can be introduced into one of the liquid components in a process known as reinforced reaction injection molding (“R-RIM”). However, the addition of short-fiber reinforcing materials causes the viscosity of the reaction mixture to build during the R-RIM process. This viscosity increase places severe limits on the amount of short-fiber reinforcing material that can be incorporated during the R-RIM process, thus making it difficult to achieve the reinforcement that is desired in the final product.

Another method of making reinforced shaped moldings includes placing a long-fiber reinforcing material within the mold cavity before the reaction mixture is injected into the mold cavity. For example, reinforced polyurethane-urea moldings are routinely produced by a long-fiber reinforcing process called structural reaction injection molding (“S-RIM”). The S-RIM process includes the formation of the reaction mixture by impingement mixing of the polyisocyanate liquid stream with the organic isocyanate liquid stream. The liquid reaction mixture is then transferred to a heated metal mold cavity that contains a long fiber reinforcing material, such as a glass fiber mat. As the reaction mixture enters the mold cavity, it penetrates the glass fiber mat and cures to form a shaped reinforced polyurethane-urea molding. The glass fiber mat provides the necessary stiffness (i.e. high flexural modulus) and toughness (i.e. high ratio of break to yield strain) to the polyurethane-urea molding that is needed for the molding's particular end use.

To reduce reinforced shaped molding weight and process costs, as well as improve mold filling, moldings produced by an S-RIM process are typically expanded by foaming. Foamed S-RIM moldings, often referred to as low density S-RIM (or “LD-S-RIM”), are especially useful in automotive applications such as interior trim parts, door panels, package trays, speaker enclosures and seat pans. Foaming is achieved by incorporating a foaming agent during the S-RIM process. The foaming agent, for example water, is generally added to the organic isocyanate liquid stream before the stream is mixed with the polyisocyanate liquid stream. Foaming occurs due to the formation of carbon dioxide that is produced by the reaction of the polyisocyanate with water.

As noted above, glass fiber mats can be used as the long-fiber reinforcing material in industrial moldings processes that produce S-RIM and LD-S-RIM moldings. Glass fiber mats offer desirable combinations of high strength, high stiffness, and low cost. Unfortunately, concerns have been raised about the irritation associated with the physical handling of glass fibers. In addition, physical handling of the glass fiber mats during the placement of the glass fiber mats in the mold cavity can also be labor intensive.

Other types of long-fiber reinforcing material can be used in place of glass fiber mats, such as an organic-fiber based reinforcing material, but they have generally failed to deliver the same structural benefits that are found in reinforced moldings made using glass fiber mats. Furthermore, long-fiber reinforcing materials, as a class, interfere with mold filling during the S-RIM process, because the liquid reaction mixture must flow through the fibrous material. This places severe constraints on the reaction mixture, such as an increased rate of viscosity, which is not otherwise found.

One method of solving problems posed by mold filling during S-RIM processing has been the use of an “open-pour” process. In an open-pour process, the reaction mixture is poured over the long-fiber reinforcing material in an open mold. The mold is then rapidly closed for the final foaming and curing stage. Open-pour processing however is very complex, and often involves the use of robots to execute the proper pour pattern. The open pour process also requires a significant amount of monitoring and process engineering to minimize scrap rates and maintain a profitable operation.

Thus, there is a need for structural moldings that can be produced using a RIM process, that have the stiffness and toughness that is associated with moldings that are fiber-reinforced, but do not contain fibrous materials.

### BRIEF SUMMARY OF THE INVENTION

The present invention provides a reaction system for particularly suitable for use in producing unreinforced structural foam moldings. The reaction system includes a polyisocyanate component, an organic isocyanate-reactive component, an isocyanate-reactive foaming agent, and optionally an additive component. The polyisocyanate component has a number averaged isocyanate functionality of at least 1.8 to 4.0 and can include an aromatic organic polyisocyanate. The organic isocyanate-reactive component includes an organic polyol containing at least one aliphatic tertiary-amine group. The isocyanate-reactive foaming agent can include water, carboxylic acids, or mixtures thereof. The additive component, if present, is generally an internal mold release agent.

The present invention also provides a process for making molded articles and is particularly useful for making an unreinforced structural foam molding by first blending the unreinforced reaction system together to form a liquid reacting mixture. The liquid reacting mixture is injected into a mold and allowed to foam and solidify within the mold. The unreinforced structural foam molding is removed from the mold.

The present invention also provides a molded article such as an unreinforced structural foam molding prepared according to the process of the present invention.

### DETAILED DESCRIPTION OF THE INVENTION

The reaction system of the present invention includes a polyisocyanate component, an organic isocyanate-reactive component, an isocyanate-reactive foaming agent, and optionally one or more additives.

Polyisocyanate Component

The reaction system includes a polyisocyanate component that contains free organically bound isocyanate (—NCO) groups at a concentration of between about 5% and about 50% by weight of the total weight of the polyisocyanate component. Preferably, the —NCO group concentration is between about 10% and about 40% by weight of the total weight of the polyisocyanate component, and still more preferably between about 15% and about 34% by weight of the total weight of the polyisocyanate component.

The polyisocyanate component includes organic polyisocyanates having a number averaged isocyanate functionality of at least 1.8 to about 4.0. In practicing the more preferred embodiments of the invention, the number averaged isocyanate functionality of the polyisocyanate composition is from about 2.0 to about 3.0, and more preferably from about 2.3 to about 2.9.

The organic polyisocyanates that may be used to form the polyisocyanate component include at least one aliphatic, cycloaliphatic, araliphatic, or aromatic organic polyisocyanate known to those skilled in the art. Especially preferred are those organic polyisocyanates that are in a liquid form at 25° C. Examples of suitable organic polyisocyanates include 1,6-hexamethylenediisocyanate; isophorone diisocyanate; 1,4-cyclohexane diisocyanate; 4,4′-dicyclohexylmethane diisocyanate; 1,4-xylylene diisocyanate; 1,4-phenylene diisocyanate; 2,4-toluene diisocyanate; 2,6-toluene diisocyanate; 4,4′-diphenylmethane diisocyanate (4,4′-MDI); 2,4′-diphenylmethane diisocyanate (2,4′-MDI); polymethylene polyphenylene polyisocyanates (crude, or polymeric MDI); and 1,5-naphthalene diisocyanate.

In general, aromatic organic polyisocyanates are the more preferred organic polyisocyanates for use as the polyisocyanate component of the present invention. Preferred aromatic organic polyisocyanates include 4,4′-MDI, 2,4′-MDI, polymeric MDI, and MDI variants. For example, the aromatic organic polyisocyanate forming the polyisocyanate component can include one or more MDI series polyisocyanates having a free —NCO group concentration of between 18% and 33.6% by weight of the total weight of the polyisocyanate component.

In addition to the above organic polyisocyanates, organic polyisocyanate variants, for example polyisocyanates that have been modified by the introduction of urethane, allophanate, urea, biuret, carbodiimide, uretonimine, isocyanurate, and/or oxazolidone residues, can also be used in forming the polyisocyanate component.

Organic isocyanate terminated prepolymers may also be employed as the polyisocyanate component. Such terminated prepolymers can be prepared by reacting a molar excess of polymeric or pure polyisocyanate with one or more polyols. The polyols can include aminated polyols, imine or enamine modified polyols, polyether polyols, polyester polyols or polyamines. Pseudoprepolymers, which are a mixture of isocyanate terminated prepolymer and one or more monomeric di- or polyisocyanates, may also be used to form the polyisocyanate component.

Commercially available polyisocyanate components that can be used in the present invention include RUBINATE® brand polyisocyanate products (available from Huntsman International LLC). An example of a preferred commercial polyisocyanate component particularly suitable for use in the unreinforced reaction system of the present invention is RUBINATE® 8700 isocyanate. This liquid polyisocyanate component is of the polymeric MDI type and has an —NCO group concentration of 31.5% by weight and a number averaged isocyanate group functionality of 2.7.

Organic Isocyanate-Reactive Component

The reaction system of the present invention also contains an organic isocyanate-reactive component that includes at least one organic polyol. The organic polyol that forms the isocyanate-reactive component is entirely separate and distinct from any polyols that may have been incorporated into the polyisocyanate component in the form of isocyanate terminated prepolymers or pseudoprepolymers.

The isocyanate-reactive component generally includes, at greater than 50% by weight of the total weight of the organic isocyanate-reactive component, an organic polyol having at least one aliphatic tertiary amine group (aliphatic tertiary amine meaning a tertiary amine in which all three of the organic carbon substituents attached to the nitrogen atom are aliphatic). Preferably, the tertiary amine-containing organic polyol comprises greater than 70% by weight of the organic isocyanate-reactive component, more preferably greater than 80% by weight of the organic isocyanate-reactive component, and most preferably at least 90% by weight of the organic isocyanate-reactive component.

The tertiary amine-containing organic polyol is essentially free of isocyanate-reactive functional groups other than primary and/or secondary alcohol groups. In one embodiment, at least 60 mole percent of the hydroxyl groups on the tertiary amine-containing organic polyol are secondary aliphatic hydroxyl groups with the remaining hydroxyl groups consisting of primary aliphatic hydroxyl groups.

The tertiary amine-containing organic polyol can also further be characterized by having a number averaged hydroxyl equivalent weight of greater than 70 to less than 450 and a number averaged hydroxyl functionality of greater than 2 to less than 8. In one embodiment, the tertiary amine-containing organic polyol has a number averaged hydroxyl equivalent weight of greater than 80 to less than 150, a number averaged hydroxyl functionality of greater than 2.5 to less than 6, and predominantly secondary aliphatic hydroxyl groups as the isocyanate-reactive functional groups.

The tertiary amine-containing organic polyol also preferably has a number averaged molecular weight in the range of greater than 200 to less than 1500. More preferably, the tertiary amine-containing organic polyol has a number averaged molecular weight within the range of greater than 240 to less than 500, and most preferably a number averaged molecular weight greater than 250 to less than 400.

The tertiary amine-containing organic polyol can also contain at least two oxyethylene units and greater than 1.5 ether linkages, on a number averaged basis. Preferably, the tertiary amine-containing organic polyol contains greater than two oxyethylene units and greater than 1.7 ether linkages, on a number averaged basis. More preferably, the tertiary amine-containing organic polyol contains a plurality of ether linkages. The expression “plurality of ether linkages” is understood to mean two or more ether linkages per molecule, on a number averaged basis. In addition, the tertiary amine-containing organic polyol can contain from about 1 to about 2 aliphatic tertiary amine groups on a number averaged basis, and most preferably 1 aliphatic tertiary amine groups, on a number averaged basis.

The tertiary amine-containing organic polyol can be selected from a group that includes the adducts of ammonia with both ethylene oxide and propylene oxide and the adducts of ethylene diamine with both ethylene oxide and propylene oxide as well as blends of these adducts.

An example of a preferred tertiary amine-containing organic polyol suitable for use as the organic isocyanate-reactive component of the present invention is JEFFOL® A-630 polyol, which is available from Huntsman Petrochemical Corporation. JEFFOL® A-630 polyol is formed by the sequential addition of ethylene oxide onto ammonia and then propylene oxide onto the resulting intermediate adduct. The A-630 polyol has a hydroxyl number of about 630, a number averaged hydroxyl equivalent weight of about 89, a number averaged molecular weight of about 267, and contains, on average, greater than two oxyethylene units per molecule and greater than 1.8 ether linkages per molecule. The hydroxyl groups on this organic polyol are predominantly secondary aliphatic alcohol groups.

The organic isocyanate-reactive component may also optionally contain, in addition to the tertiary amine-containing organic polyol, one or more additional organic polyols that are different from the tertiary amine-containing organic polyols defined above, under the proviso that the optional one or more organic polyols that make up the organic isocyanate-reactive component conforms to the specifications provided above. In these embodiments, the one or more organic polyols that are blended with the tertiary amine-containing organic polyol are preferably polyether polyols.

For example, in one embodiment of the present invention the organic isocyanate-reactive component consists of a tertiary amine-containing organic polyol and at least 10% by weight, and more preferably greater than 15% by weight, a polyether polyol. The polyether polyol is based predominantly, on ethylene oxide (on a weight basis), and is characterized by having at least 3 oxyethylene units per molecule on a number averaged basis and greater than two ether linkages on a number averaged basis. For example, the polyether polyol can have a number averaged molecular weight of greater than 150 to less than 900, preferably greater than 190 to less than 800, and more preferably greater than 194 to less than 700 with greater than 70% of the molecular weight of the polyether polyol due to oxyethylene units. A further example of a preferred polyether polyol that can be used as the second organic polyol is propoxylated trimethylolpropane having a number averaged molecular weight in the range of from about 700 to about 1400.

The polyether polyol can also include a number averaged functionality of primary and/or secondary aliphatic alcohol groups of about 1.7 to about 3, and most preferably about 2 to 3. Examples of polyether polyols preferred for the present invention include polyoxyethylene diols having a molecular weight (number averaged) in the range of about 190 to about 800.

Some non-limiting illustrative examples of organic polyols and organic polyol blends that are suitable for use as the organic isocyanate-reactive component in the unreinforced reaction system of the present invention are as follows:

a) JEFFOL® A-630 polyol: 100% by weight of the organic isocyanate-reactive component;

b) A blend of 90% by weight JEFFOL® A-630 polyol and 10% by weight of a 200molecular weight (number averaged) polyoxyethylene glycol; and

c) A blend of 60% by weight of an adduct of 4 moles of propylene oxide onto ethylene diamine [N,N,N′,N′ tetrakis-(2-hydroxypropyl) ethylene diamine], with 40% by weight of a 200 molecular weight (number averaged) polyoxyethylene glycol.

Isocyanate-Reactive Foaming Agent

The reaction system according to the present invention also contains an isocyanate-reactive foaming agent. The isocyanate-reactive foaming agent includes chemical foaming agents selected from the group consisting of water, carboxylic acids, and blends of both water and carboxylic acids. In one embodiment of the present invention, the isocyanate-reactive foaming agent consists of water only. In another embodiment, the isocyanate-reactive foaming agent consists of carboxylic acids only. In yet another embodiment, the isocyanate-reactive foaming agent consists of water with one or more carboxylic acids. In this latter embodiment, the water preferably constitutes at least 10% by weight of the total weight of the isocyanate-reactive foaming agent, more preferably at least 15% by weight of the total weight of the isocyanate-reactive foaming agent, and still more preferably at least 20% by weight of the total weight of the isocyanate-reactive foaming agent.

The carboxylic acids used in forming the isocyanate-reactive foaming agent include at least one of an aliphatic mono, di, or poly carboxylic acids that contain 5 or more carbon atoms. Carboxylic acids that are in a liquid form at 25° C. are particularly preferred. The most preferred are the so called “fatty acids” which contain at least 10 carbon atoms per molecule and from 1 to 3 carboxyl (—COOH) groups per molecule. Among the fatty acids, those most preferred are the unsaturated fatty acids containing at least 12 carbon atoms per carboxyl (—COOH) group and at least one unit of ethylenic unsaturation per molecule, on a number averaged basis.

Specific non-limiting examples of fatty carboxylic acids which are suitable for use in forming the isocyanate-reactive foaming agent include one or more members selected from the group consisting of oleic acid, ricinoleic acid, linoleic acid, linolenic acid, tall oil fatty acids, as well as the dimerized and trimerized acids derived from these unsaturated fatty acids. These fatty acids often serve a dual purpose by also improving internal mold release properties.

Non-limiting examples of other carboxylic acids that may be used include adipic acid, fumaric acid, maleic acid, succinic acid, sebacic acid, the carboxylic acids formed from the addition of cyclic carboxylic acid anhydrides onto alcohols or polyols, or mixtures of these. In a particular embodiment of the invention, the carboxylic acids are free of isocyanate-reactive hydrogen atoms other than the carboxylic acid (—COOH) groups themselves.

The isocyanate-reactive foaming agent is generally added to the organic isocyanate-reactive component during processing. Therefore, carboxylic acids that are soluble in the organic isocyanate-reactive component, under the conditions used during RIM processing, are preferred. The weight ratio of the organic isocyanate-reactive component to the isocyanate-reactive foaming agent is typically greater than 2:1, preferably greater than 3:1, and still more preferably greater than 4:1; but generally is less than 200:1.

It will be appreciated by those skilled in the art that the carboxylic acids, when used in the unreinforced reaction system, will become at least partially ionized when combined with the organic isocyanate-reactive component.

An unexpected and surprising catalytic effect has also been observed when a carboxylic acid is incorporated into the reaction system of the present invention. This effect is not observed in conventional RIM formulations. This catalytic effect can be used to reduce or eliminate the need for conventional catalysts in the inventive reaction system. Although it is within the scope of the invention to use conventional catalysts [as part of the optional additives component], the ability to reduce or eliminate these conventional catalysts is considered a benefit. The conventional catalysts, especially amine catalysts, tend to be volatile, and often cause unwanted odors and staining problems in the composite molding.

Additives Component

The reaction system may also optionally contain one or more additives that form an additive component. These additives include one or more additives already known in the polyurethane art. Preferably, the additives are limited to those that are already in use in the RIM art. The additive component can comprise from 0 to less than 20% by weight of the total weight of the reaction system, preferably 0 to less than 15% by weight, still more preferably 0 to less than 10% by weight, and most preferably 0 to 5% by weight of the total weight of the reaction system. The additive component excludes long-fiber reinforcing materials, and preferably excludes all solid fillers. The additive component also excludes most physical blowing agents, although it is within the scope of the invention to enhance foaming via the dissolving or dispersing of atmospheric gases into one or more of the liquid streams. The atmospheric gases that may be used for this purpose include air, nitrogen, carbon dioxide, oxygen, argon, and mixtures of these gases. These atmospheric gases are commonly used as additives for bubble nucleation in RIM processing, and are considered separate from the isocyanate-reactive foaming agents discussed above. In addition, the additive component also preferably excludes other chemical blowing agents. Moreover, it is preferred that the additive component is free of any catalysts or compounds which react with the isocyanate groups of the other components under the normal conditions during RIM processing.

Examples of additives which may be used to make up the additive component include fire retardants, catalysts for the reactions of isocyanates, surfactants, pigments, dyes, smoke suppressants, antioxidants, UV light stabilizers, plasticizers, diluents (preferably those having boiling points of 200° C. or greater at 1 atmosphere pressure), internal mold release agents [other than the carboxylic acids] and antistatic agents. Since the additive component is generally added to the organic isocyanate-reactive component, the preferred additives of the present invention are those that are soluble in the organic isocyanate-reactive component.

In one embodiment, the additive component includes internal mold release agents. Many different kinds of internal mold release agents are known in the art. For example, the internal mold release agents can include the complex, and essentially inert, fatty polyesters described in U.S. Pat. No. 5,576,409 and U.S. Pat. No. 5,670,553, the disclosures of which are incorporated by this reference. A preferred member of this class is LOXIOL G-71S polyester, which is commercially available from Henkel Corporation. This and other complex fatty polyester internal mold release agents work synergistically with fatty carboxylic acids. The fatty carboxylic acids, when used during the present invention, are part of the isocyanate-reactive foaming agent defined above.

It is desirable that the reaction system be essentially free of volatile organic solvents (“VOC's ”) and other volatile non-isocyanate-reactive organic ingredients that may be considered VOC's under environmental regulations. Therefore, it is highly preferable that the additives used as the additive component be essentially free of any non-isocyanate-reactive organic species boiling at lower than 150° C. at 1 atmosphere pressure, and more preferably essentially free of any non-isocyanate-reactive organic species boiling at less than 200° C. at 1 atmosphere pressure. Even more preferable is that the additive component, and the reaction system in general, be essentially free of non-isocyanate-reactive organic species boiling at lower than 250° C. at 1 atmosphere pressure, and most preferably be essentially free of such organic species boiling at 260° C. or lower at 1 atmosphere pressure. By “non-isocyanate-reactive” it is meant that the species in question will not react with the polyisocyanate component during RIM processing, and thereby remains unreacted in the polymer. By “essentially free” means the additive component and the reaction system itself both contain less than 1% by weight of these volatile organic species, more desirably less than 0.5% by weight, most preferably less than 0.1% by weight, and ideally 0%.

RIM Process and Unreinforced Structural Foam Moldings

The present invention further includes an RIM process for making unreinforced structural foam moldings through the use of the reaction system. Generally, during the RIM process, the reaction system is formulated into at least two liquid chemical streams. The two liquid streams are metered at a controlled ratio from a storage tank and blended together to form a liquid reacting mixture. The liquid reacting mixture is injected into a mold, where it foams to fill the mold, and then cures to form an unreinforced structural foam molding. Once the mold is opened, the unreinforced structural foam molding is removed.

The RIM process is facilitated by a reaction injection molding apparatus that includes separate tanks for the liquid chemical streams, means for metering each chemical stream, means for blending the liquid chemical streams together to form the liquid reacting mixture, and means for either pouring the liquid reacting mixture into an open mold or injecting the liquid reacting mixture into a closed mold.

Although the use of two liquid chemical streams during processing is highly preferred, the reaction system may be formulated (or divided up) into three or more liquid chemical streams. The composition of each liquid chemical stream is, of course, limited by the reaction chemistry. Therefore, each component within the reaction system that reacts when combined with the other components should be separated into different chemical streams until final blending.

In one embodiment (where two liquid chemical streams encompass the reaction system), the polyisocyanate component is a separate liquid chemical stream, known as the A component. The second liquid chemical stream, or the B component, contains a blend of the organic isocyanate-reactive component, the isocyanate-reactive foaming agent and the optional additive component. It is within the scope of the invention, although generally less preferred, to incorporate at least some of the optional additive component into the A component under the proviso that the addition of the additive component to the A component still allows for stable processing.

During the metering and blending steps of the RIM process, the weight ratio of the A and B components are controlled by the reaction injection molding apparatus so as to achieve a pre-determined and consistent stoichiometry of isocyanate (—NCO) to isocyanate-reactive groups. This stoichiometry (the ratio of —NCO groups to isocyanate reactive groups) is called the Index, and is typically in the range of 0.8 to 1.3, but may extend as high as 15 if the reaction system contains a catalyst for the trimerization of isocyanate groups. A particularly preferred range of Index values for the present invention is from 0.95 to 1.2, more preferably 1.00 to 1.15, and most preferably form 1.02 to 1.10.

The weight ratio of the A and B components is determined in part by the requirements of the reaction stoichiometry (Index), and in part by the selection of the raw materials that go into the reaction system. Those skilled in the reaction injection molding art will understand how to formulate two-component liquid streams in order to control both the weight ratio of the two liquid chemical streams, and the reaction stoichiometry. A preferred range of A/B component weight ratios is from 4:1 to 1:4, more preferably from 3:1 to 1:3, still more preferably 2:1 to 1:2, and even more preferably 1.5:1 to 1:1.5. Ratios near 1:1 are generally preferred, over ratios that are relatively far from 1:1 for ease of processing.

The A and B components are necessarily fluid under the conditions of RIM processing, and it is preferred that they be fully homogeneous. The A and B components are also desirably liquid at ambient temperatures (25° C.), for ease of storage and handling.

The reaction system according to the present invention also provides a combination of relatively long gel time and short mold residence time during RIM processing. This combination provides for the economical manufacture of large and complex parts, such as unreinforced automobile door panels. For example, the unreinforced structural moldings can be demolded within 65 seconds to 100 seconds after the pouring (or injection) of the liquid reacting mixture into the mold is complete.

Although the unreinforced structural foam moldings prepared according to the RIM process of the present invention are free of reinforcing fibers or mats, and preferably free of all solid fillers, it is within the scope of the present invention to mold structural foams that contain facing materials on one or more sides. The facing materials, when used, serve a decorative rather than a structural function and, unlike reinforcing fibers or mats, are located at the surface(s) of the molded article rather than the interior. The optional facing materials can include either vinyl, leather, or cloth based laminates. The facing material is pre-placed in the mold and the liquid reacting mixture is poured or injected behind it so that the facing becomes bonded to the surface(s) of the molded article before taking the shape of the mold. The process of making RIM structural foam moldings containing facings is typically known in the art as the “pour-behind” process. The facings used in the pour-behind process are distinct from the fibrous reinforcing structures used in conventional S-RIM and LD-S-RIM moldings, in as much as the latter (fibrous reinforcing structures) are always embedded into the bulk of the molded part.

The present invention also pertains to unreinforced structural foam moldings prepared using the RIM process according to the invention. The unreinforced structural foam molding produced according to the invention includes thermoset cellular materials, characterized by a having a thermoset resin phase and a gas phase within the cells. Once the unreinforced structural foam molding is sufficiently well cured to be handled and removed from the mold, the thermoset resin phase is characterized by having a covalently crosslinked network polymer structure. This covalent crosslinked network polymer structure is due to the presence of monomers within the reaction system which have reactive chemical group functionalities of greater than 2. Additional covalent crosslinking may derive from the presence of excess isocyanate monomers, as is the case when the index of the reaction system is greater than 1.

The unreinforced structural foam moldings according to the invention preferably have densities below a specific gravity (SPG) of 1.0. The preferred SPG range of these molded articles (as measured without any optional facings) is from 0.15 to 0.9, more preferably from 0.2 to 0.8, and most preferably from 0.5 to 0.7 SPG.

Even though the structural foam moldings produced according to the invention are unreinforced, they are necessarily stiff (high flexural modulus) materials. The flexural modulus of the unreinforced structural foam molding at ambient temperature (as measured without any optional facings) is greater than 700 MPa at 0.60 SPG, more preferably at least 800 Mpa at 0.60 SPG, and most preferably between 900 MPa and 1300 Mpa at 0.60 SPG. The flexural moduli are determined by ASTM D-790-95A at 25° C.

A particularly valuable and surprising feature of the unreinforced structural foam moldings of the present invention is that the moldings produced by the invention have a combination of high break strain with high flexural modulus, which is provided without fiber reinforcement. The ratio of the break strain to the yield strain for the unreinforced structural foam molding according to the invention (measured without any facing) is at least 1.25, but more preferably at least 1.35. These yield and break strain values are determined according to ASTM D-790-95 A at 25° C.

The following example is intended for purposes of illustration, and is not intended to limit the scope of the protection sought for the present invention.

### EXAMPLE

In the following example, all values given are percentages by weight unless indicated otherwise in Table 1 below. All (A/B) component ratios are weight ratios unless otherwise indicated. The materials making up the B component composition are defined for each example. The polyisocyanate used as the A component in each example was RUBINATE® 8700 isocyanate.

TABLE 1

| | Comparative | | | | | | |
|---|---|---|---|---|---|---|---|
| | Example | Ex. 1 | Ex. 2 | Ex. 3 | Ex. 4 | Ex. 5 | Ex. 6 |
| B-Component | | | | | | | |
| JEFFOL ® A-630 | | 88.43 | 70.48 | 55.31 | 49.96 | | 58.54 |
| polyol | | | | | | | |
| JEFFOL ® G30- | 77.28 | | | | | | |
| 650 polyol | | | | | | | |
| Polyol A | | | 8.81 | 18.43 | 16.65 | | 19.51 |
| DABCO ® CL-485 | | | | | | 45.98 | |
| catalyst | | | | | | | |
| PEG 200 | | | | | | 37.63 | |
| JEFFOL ® G31-28 | | | | 18.43 | 16.65 | | 19.51 |
| polyol | | | | | | | |
| JEFFOL ® G31-55 | | | 8.81 | | | | |
| polyol | | | | | | | |
| Glycerine | 3.86 | | | | | | |
| LOXIOL ® G71S | 7.73 | 8.84 | 8.81 | 5.53 | 8.33 | 8.36 | |
| additive | | | | | | | |
| UNITOL ® DSR | 5.02 | | | | 5.41 | 5.43 | |
| fatty acid | | | | | | | |
| PRIOLUBE ® 1414 | | 0.97 | 0.97 | | | 0.92 | |
| additive | | | | | | | |
| KEMESTER ® | 0.86 | | | | 0.92 | | |
| 5721 additive | | | | | | | |
| JEFFCAT ® | 2.70 | | | | | | |
| DMCHA catalyst | | | | | | | |
| DABCO ® 8800 | 0.77 | | | | | | |
| catalyst | | | | | | | |
| NIAX ® L-6980 | 1.16 | | | 1.38 | 1.25 | | 1.46 |
| surfactant | | | | | | | |
| NIAX ® L-550 | | 0.88 | 0.88 | | | 0.84 | |
| surfactant | | | | | | | |
| REBUS ® 2121 | | | | | | | |
| pigment | | | | | | | |
| REACTINT ® X77 | | | 0.36 | | | | |
| colorant | | | | | | | |
| Water | 0.62 | 0.88 | 0.88 | 0.92 | 0.83 | 0.84 | 0.98 |
| A-Component | | | | | | | |
| Isocyanate: R- | R-8700 | R-8700 | R-8700 | R-8700 | R-8700 | R-8700 | R-8700 |
| 8700 | | | | | | | |
| RUBINATE ® 8700 | | | | | | | |
| isocyanate | | | | | | | |
| A/B | 1.61 | 1.55 | 1.68 | 1.46 | 1.35 | 1.65 | 1.55 |

The Comparative Example and Examples 1 through 5 were evaluated by generating 6-inch by 8-inch by 0.125-inch plaques. The plaques were made by first equilibrating the A and B components to room temperature. The upper and lower plaque mold temperatures were then set at 170° F. and the mold surfaces were sufficiently covered with a thin coating of LH-1® mold release from Chem-Trend Corporation. The components making up the B component were weighed, then sufficiently blended together. The A component was added to the B component to form the liquid reacting mixture by mixing the two components in a lab mixer for about 10 seconds at a mixing speed of about 2500 rpm. The liquid reacting mixture was then immediately poured into the heated plaque mold, and the mold immediately closed. Each plaque was cured, then demolded within 90 seconds (mold residence time) of closing the mold.

The Comparative Example was molded at a 0.469 g/cm³ density. The flexural yield and break strains were 6.2% and 6.8%, respectively and the flexural modulus was 648 MPa. Example 1 was molded at a 0.578 g/cm³ density, and the flexural yield and break strains were 6.2% and 8.6%, respectively. The flexural modulus of Example 1 was 885 MPa. Examples 2 through 5 were evaluated by hand-feel. The molded density of these plaques was approximately 0.5 g/cm3.

Each example used in making the unreinforced structural foam moldings demonstrated a relatively high break strain. For examples 1 to 5, that were produced using the reaction system according to the present invention, three did not break below the 10% strain limit. However, the molding produced by the Comparative Example broke below the 10% strain limit.

It should be understood that the yield strain and break strain are independent of density, so the density differences observed in the examples would not account for differences (in yield and break strain) that is shown by the data. The flexural modulus and break strain would certainly be different, but the yield strain should not be a function of density.

In example 6, the B component was prepared by blending all components that made up the B component together in a standard mixing vessel at room temperature. Both the A and B component temperatures were equilibrated to 60° F. and then charged to a Krauss-Maffei ‘RIM-Star 16’ RIM machine that was equipped with an impingement mix head. The two components were mixed by the impingement mix head to form the liquid reacting mixture. The mix head pressure used during the preparation of the liquid reacting mixture was set at 2200 PSI. Once mixed, the liquid reacting mixture was then poured into an RIM pour-behind door panel tool. The upper and lower tool temperatures were set at 170° F. and 165° F., respectively. The unreinforced door panel molding was removed and its density was approximately 0.50 g/cm³. The door panel molding exhibited good part quality and high strength.

The following list describes the components used in the examples above:

DABCO® 8800 catalyst: is a proprietary delayed-action tertiary amine based catalyst formulation, available from Air Products and Chemicals Corporation;

DABCO® CL485 polyol: is propoxylated ethylene diamine with a hydroxyl value of 770 available from Air Products and Chemicals Corporation;

JEFFOL® A630 polyol: is a propoxylated triethanolamine of hydroxyl number 635, available from Huntsman Petrochemical Corporation;

JEFFOL® G30-650 polyol: is a propoxylated glycerol of hydroxyl number 650, available from Huntsman Petrochemical Corporation;

JEFFOL® G31-28 polyol: is an alkoxylated glycerol of hydroxyl number 28, available from Huntsman Petrochemical Corporation;

JEFFOL® G31-55 polyol: is an alkoxylated glycerol of hydroxyl number 55, available from Huntsman Petrochemical Corporation;

JEFFCAT® DMCHA catalyst: is N,N-dimethyl cyclohexylamine, available Huntsman Petrochemical Corporation;

KEMESTER® 5721 additive: is tridecyl octadecanoate, available from Witco Corporation;

LOXIOL® G71S additive: is an inert fatty polyester, available from Henkel Corporation;

NIAX® L550 surfactant: is a proprietary silicone surfactant composition, believed to contain polydimethylsiloxane-polyoxyalkylene copolymers, available from OSI Division of Witco Corporation;

NIAX® L6980 surfactant: is a proprietary silicone surfactant composition, believed to contain polydimethylsiloxane-polyoxalkylene copolymers, available from OSI Division of Witco Corporation;

PEG 200 polyol: is ethoxylated ethylene glycol with a molecular weight of 200; available from Huntsman Petrochemical Corporation;

Polyol A: is propoxylated trimethylol propane of hydroxyl number 930;

PRIOLUBE® 1414 additive: is isobutyl oleate, available from Uniqema Division of ICI Corporation;

REACTINT® X77 colorant: is a proprietary polymeric colorant, available from Milliken Chemical;

REBUS® 2121 pigment: is a pigment concentrate, comprising a polyester polyol and dispersed carbon black, available from Rebus Incorporated;

UNITOL® DSR fatty acid: is a Tall Oil fatty acid composition, available from Union Camp Corporation; and

RUBINATE® 8700 isocyanate: is a high functionality mixture of diphenylmethane diisocyanates and polymethylene polyphenyl polyisocyanates, available from Huntsman International LLC.

The present invention has been described by way of illustration and example for the purposes of clarity of understanding. The above examples are provided for exemplification purposes only, and are not intended to limit the scope of the invention, which has been described in broad terms before the examples. It will be readily apparent to one skilled in the art, that, in light of the teachings of this invention, changes and modifications can be made without departing from the spirit and scope of the present invention.

What is claimed is:

1) A reaction system comprising:
a) a polyisocyanate component having a number averaged isocyanate functionality of at least 1.8 to 4.0;
b) an organic isocyanate-reactive component comprising at least fifty (50) percent by weight, based on the total weight of the organic isocyanate-reactive component, of an organic polyol having at least one aliphatic tertiary amine group and a number averaged hydroxyl equivalent weight of greater than 70 to less than 450; and
c) an isocyanate-reactive foaming agent selected from the group consisting of water, carboxylic acids, and mixtures thereof.

2) The reaction system according to claim 1 wherein the polyisocyanate component is an aromatic organic polyisocyanate.

3) The reaction system according to claim 2 wherein the aromatic organic polyisocyanate is a polymethylene polyphenylene polyisocyanate.

4) The reaction system according to claim 1 wherein the organic isocyanate-reactive component further comprises a polyoxyethylene diol having a number averaged molecular weight of about 190 to about 800.

5) The reaction system according to claim 4 wherein the organic isocyanate-reactive component further comprises a propoxylated trimethylolpropane having a number averaged molecular weight of about 700 to about 1400.

6) The reaction system according to claim 1 wherein the reaction system further comprises less than fifteen (15) percent by weight of an internal mold release agent, based on the total weight of the reaction system.

7) A reaction system for producing unreinforced molded articles comprising:
a) a polyisocyanate component comprising at least one organic polyisocyanate having a free organically bound isocyanate group concentration of between about 5% to about 50% by weight of the total weight of the polyisocyanate component;
b) an organic isocyanate-reactive component comprising at least fifty (50) percent by weight, based on the total weight of the organic isocyanate-reactive component, of an organic polyol having at least one aliphatic tertiary amine group; and
c) an isocyanate-reactive foaming agent comprising water and at least one carboxylic acid, wherein the water constitutes at least 10% by weight, based on the total weight of the isocyanate-reactive foaming agent.

8) The reaction system according to claim 7 wherein the polyisocyanate component has a number averaged isocyanate functionality of at least 1.8 to 4.0.

9) The reaction system according to claim 7 wherein the polyisocyanate component is an aromatic organic polyisocyanate.

10) The reaction system according to claim 9 wherein the aromatic organic polyisocyanate is a polymethylene polyphenylene polyisocyanate.

11) The reaction system according to claim 7 wherein the organic polyol has a number averaged hydroxyl equivalent weight of greater than 80 to less than 150 and greater than 1.7 ether linkages per molecule on a number averaged basis.

12) The reaction system according to claim 11 wherein the organic isocyanate-reactive component further comprises a polyoxyethylene diol with a number averaged molecular weight of about 190 to about 800.

13) The reaction system according to claim 11 wherein the organic isocyanate-reactive component further comprises a propoxylated trimethylolpropane having a number averaged molecular weight of about 700 to about 1400.

14) The reaction system according to claim 7 wherein the carboxylic acid is selected from the group consisting of oleic acid, ricinoleic acid, linoleic acid, linolenic acid, adipic acid, fumaric acid, maleic acid, succinic acid, and sebacic acid.

15) The reaction system according to claim 7, wherein the reaction system further comprises less than fifteen (15) percent by weight of an internal mold release agent, based on the total weight of the reaction system.

16) A process for preparing a molded foam comprising the steps of:
a) providing a reaction system comprising: (i) a polyisocyanate component having a number averaged isocyanate functionality of at least 1.8 to 4.0, (ii) an organic isocyanate-reactive component comprising at least fifty (50) percent by weight, based on the total weight of the organic isocyanate-reactive component, of an organic polyol having at least one aliphatic tertiary amine group and a number averaged hydroxyl equivalent weight of greater than 70 to less than 450, and (iii) an isocyanate-reactive foaming agent selected from the group consisting of water, carboxylic acids, and mixtures thereof;
b) combining the reaction system to form a liquid reacting mixture;
c) injecting the liquid reacting mixture into a mold;
d) allowing the liquid reacting mixture to foam and cure in the mold to form a molded foam; and
e) removing the molded foam from the mold.

17) The process according to claim 16 wherein the reaction system is separated into an A component containing the polyisocyanate component and a B component containing the isocyanate-reactive component and the isocyanate-reactive foaming agent.

18) The process according to claim 17 wherein the A component and B component are blended to achieve an Index of 0.8 to 1.3.

19) The process according to claim 18 wherein the mold contains a facing material.

20) A molded foam produced according to the process of claim 16.
